(19) United States
(12) Patent Application Publication
(10) Pub. No.: US 2005/0233645 A1
(43) Pub. Date: Oct. 20, 2005

(54) Smart card receiver allowing two card orientations

(76) Inventors: Bruno Michel, Dole (FR); Sylvain Rochon, Dole (FR); Fabrice Valcher, Dole (FR)

Correspondence Address: LEON D. ROSEN;FREILICH, HORNBAKER & ROSEN, Suite 1220, 10960 Wilshire Blvd., Los Angeles, CA, 90024, US

(21) Appl. No.: 11/146,529

(22) Filed: Jun. 7, 2005

Related U.S. Application Data
(63) Continuation-in-part of application No. PCT/EP03/50952, filed on Dec. 5, 2003.

(30) Foreign Application Priority Data
Dec. 12, 2002 (FR) 0215698

(51) Int. Cl. H01R 24/00

(52) U.S. Cl. 439/630

(57) ABSTRACT

A smart card receiver with a card receiving cavity, has upper and lower sets of contact blades for engaging the card contact pads when the card is inserted in the ususal orientation with its contacts pads facing downwardly, or when inserted in a second orientation with its contact pads facing upwardly. The card receiver has card confining-walls that are preferably devoid of a polarizing wall, so the card is inserted in the same position whether the card is inserted right-side-up or upside-down. The upper contact blades are transversely offset from the lower contact blades, to enable the reading of cards whose contact pads are offset from an imaginary centerline of the card. The housing of the card receiver includes an upper structure that forms the upper wall of the cavity at the contact blades, with the upper structure having downward projections at the front and rear of the receiver that form both upper and lower walls of the card-receiving cavity.

### CROSS-REFERENCE

This is a continuation-in-part of PCT application PCT/EP 2003/050952 filed 5 Dec. 2003 which named the US and which claimed priority from French application 0215698 filed 12 Dec. 2002.

### BACKGROUND OF THE INVENTION

The present invention relates to a receiver for electrical connection of a contact-type integrated-circuit card, also called an electronic memory card, chip card or smart card.

The invention relates more particularly to a receiver for a card of rectangular general shape of the type having, on its main face, conducting contact pads which are connected to the memory contained in the card and which must connect to a read and/or write device to use data contained in the card.

According to a known technique, the card is electrically connected by means of a component, generally called an electrical connector, which is essentially formed from an insulating body that carries elastically deformable contact blades, each of which has a convex curved end capable of establishing electrical contact with the corresponding pad on the smart card.

The quality of the electrical connection depends, of course, on correct positioning, and reliable retention in this correct position, of the conducting pads relative to the blades of the connector, that is to say of the card relative to the electronic equipment, or more particularly relative to a printed-circuit board of this equipment that carries the electrical connector.

### SUMMARY OF THE INVENTION

The invention aims to provide a receiver which allows the card to be electrically connected whatever the orientation—face down or face up—of the main face of the card on which the conducting pads lie.

For this purpose, the receiver includes an upper crosspiece, parallel to a lower crosspiece, which carries a group of upper electrical contact blades, each of which has a curved contact end of downwardly oriented convexity in order to cooperate with an associated conducting pad on the main face of the card when said face is face up. In this way, the receiver has two connectors, namely a lower one and an upper one, the respective lower and upper contact blades of which allow electrical connection to the conducting pads on the card irrespective of the orientation of the latter.

According to other features of the invention:
the insulating body of the lower connector is an attached element fixed to the upper face of the lower crosspiece;
the insulating body of the lower connector is molded as one piece with the lower crosspiece;
the insulating body of the upper connector is molded as one piece with the upper crosspiece;
the main face of the card includes at least one pair of longitudinally aligned front and rear conducting pads and each group of lower and upper contact blades includes at least one pair of contact blades each having a front contact blade and a rear contact blade that are aligned longitudinally, the curved contact end of the front contact blade being longitudinally offset toward the front relative to that of the rear contact blade;

the main face of the card includes two series, namely a front one and a rear one, of conducting pads that are transversely aligned and longitudinally offset so as to constitute a series of pairs of transversely offset conducting pads and each group of lower and upper contact blades includes two series of contact blades, namely a front one and a rear one, that are transversely aligned so as to constitute a series of pairs of transversely offset contact blades;
each upper contact blade has a rear contact portion shaped with a curved contact end, a horizontal intermediate portion for fitting the blade into the insulating body and a rear vertical portion for electrical connection of the blade, and, in a pair of upper blades, the two horizontal intermediate portions are superposed vertically and the two vertical connection portions are longitudinally offset relative to each other.
each vertical connection portion is bent down through approximately 90° after the intermediate portion has been fitted into the insulating body;
the insulating body includes, for each pair of upper contact blades, a vertical notch open longitudinally rearward, which, after the two vertical connection portions have been bent down, receives said connection portions and which includes means for the relative positioning and for the retention of the two vertical connection portions;
the intermediate portion is fitted into the insulating body by rearward longitudinal insertion from the front;
the upper crosspiece is offset longitudinally forward relative to said upper plate.
Other features and advantages of the invention will become apparent on reading the detailed description that follows, to understand which reference should be made to the appended drawings.

### BRIEF DESCRIPTION OF THE DRAWINGS

FIG. 1 is a top view of one embodiment of a receiver case according to the teaching of the invention;

FIG. 2 is an end view, from the rear, looking along the direction of the arrow F2 of FIG. 1;

FIG. 3 is a sectional view on a larger scale on the line 3-3 of FIG. 1;

FIG. 4 is an isometric bottom view of the receiver case shown in FIGS. 1 to 3;

FIG. 5 is a top view similar to that of FIG. 1, in which the receiver case is shown with a SIM card in contact position in the case, with its main face facing down;

FIG. 6 is an isometric view, and on a large scale, looking along the direction of the arrow F6 of FIG. 1, which illustrates an alternative embodiment of the insulating body and of the upper contact blades;

FIG. 7 is a schematic top view of a portion of a printed-circuit board intended to hold the receiver case shown in the preceding figures; and

FIG. 8 is a schematic view of the front longitudinal end portion of the main face of a SIM card intended to be inserted into the receiver case according to the invention.

### DESCRIPTION OF THE PREFERRED EMBODIMENTS

1. Limited Description of the Invention

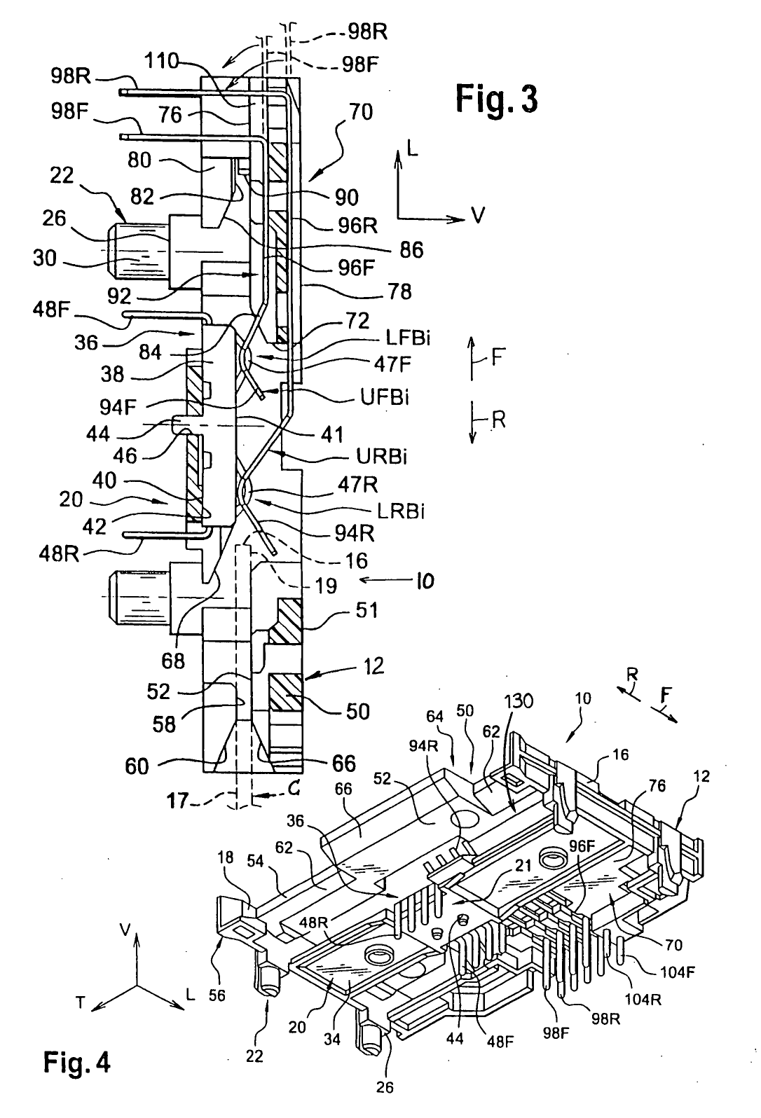

FIG. 4 shows a smart card receiver 10 which has a card-receiving cavity 130 that receives a smart card that is inserted in a forward direction F into the cavity. FIG. 2 shows card confining wall surfaces 52, 58 at the top and bottom of the cavity, and side walls surfaces 18 at the opposite sides of the cavity. FIG. 3 shows that the card is inserted forwardly F to a fully inserted position wherein a front edge of the card abuts a front edge 90 of the cavity. The card receiver has contact blades, including lower forward contact blades LFBi and lower rearward contact blades LRBi. The contact blades have contacting parts 47F and 47R for engaging contact pads on the smart card.

FIG. 8 shows that the smart card C has opposite side edges, or sides 14, a front edge 16, a main face 17, and an opposite second face 132. The card has internal circuitry (not shown) which is connected to a set of contact pads 140 lying on its main face 17. There normally are no contact pads on the second face. FIG. 8 shows eight contact pads 140. The card has an imaginary centerline 142 lying halfway between the opposite sides 14 of the card. The set of contact pads is centered on an imaginary pad pattern centerline 144 that is offset a distance D from the card centerline 142. FIG. 8 also shows, in phantom lines, one polarizing front card corner 150, which some cards have and which has a surface extending 45° to the front and side edges. The opposite front corner 152 is not polarized.

Prior smart card receivers can connect to a smart card only when the card has been inserted in an orientation wherein the card main face faces downward. This assures that the contact pads on the card are engaged by contact blades lying at the bottom of the card-receiving cavity. Some prior card receivers for certain cards with polarized corners, assure this by using a barrier that prevents full card insertion unless the card is inserted so the barrier receives the polarizing corner of the card. Many people are not sure which card side should face downward during card insertion, and have to withdraw the card and reinsert it upside down before the card receiver can read/write the card.

In accordance with the present invention, the present smart card receiver allows the card to be fully inserted in its right-side-up orientation (with the pads facing downward) or its upside-down orientation (with the pads facing upward), and assures that the card contact pads will be engaged by contact blades in either orientation. FIG. 3 shows that the card receiver has forward and rearward upper contact blades UFBi and URBi with card-engaging contacting parts. When the card is inserted upside-down (with its contact pads facing upward) the upper contact blades engage the contact pads and the lower contact blades do not engage any contact pads.

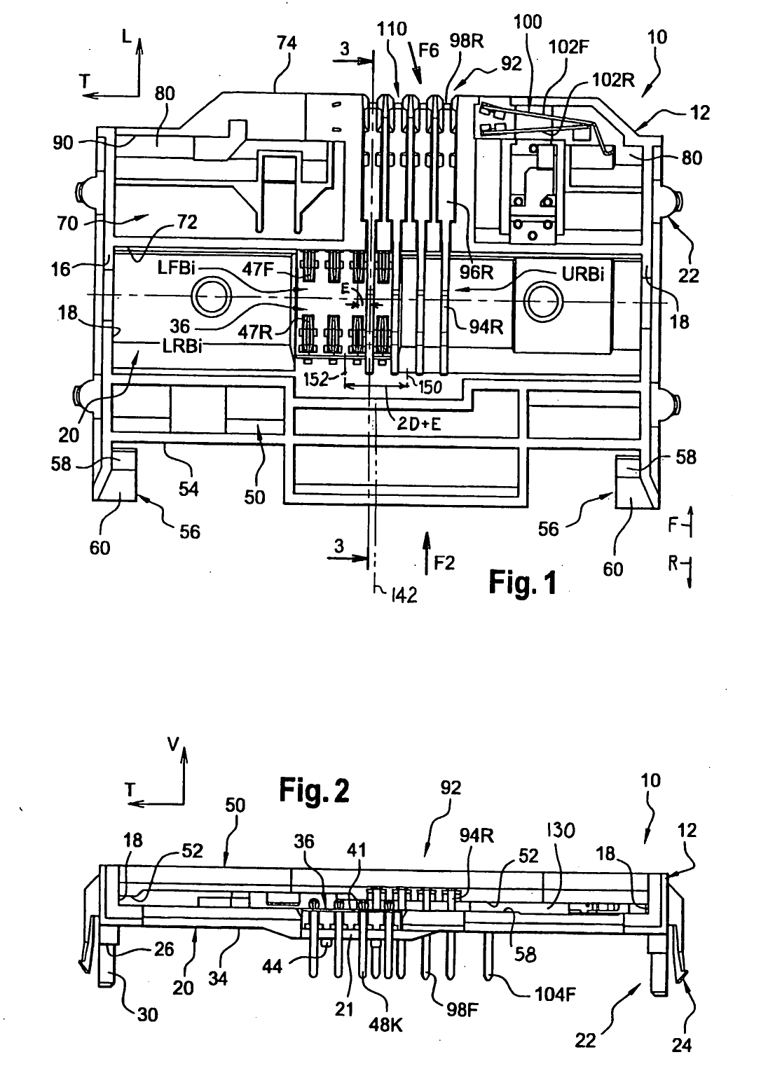

As mentioned above, the set of contact pads on the card main face 17 shown in FIG. 8, are offset a distance D from the card centerline 142. As a result, when the card is turned upside-down, the set of contact pads shifts transversely by a distance 2D. FIG. 1 shows that the centerline 150 of the group of eight upper contacting parts such as 94R, are offset by a distance of 2D plus E from the centerline 152 of the group of eight lower contact blade card-engaging contacting parts. E is the transverse T distance between two adjacent contacts (their contacting parts) of a set.

The slight addition E in offset is provided to assure that the contacting parts of the upper and lower contacts do not press directly against each other. The top of the card engaging parts such as 47F and 47R are curved about two horizontal axes of curvature, and if the upper and lower blade contacting parts directly engaged each other they might slide past one another while pressing sideways against each other and become damaged. Also, if the upper and lower contacts are all connected to active circuit conductors, unwanted connections might be made. FIG. 1 shows that the contacting part 94R of one upper contact lies transversely between two lower contacting parts.

Where each card to be received has a polarizing corner, then instead of providing a single stop 90 that engages the front edge of the card (away from the polarizing corner wall 150 of FIG. 8), it is possible to have two stops. One stop would engage the polarizing corner wall 150, and therefore allow the card to move further forward in one card orientation (e.g. with its main face down), than the card can move in the other orientation (with the main face up). Then, the upper and lower contact blades would have card-engaging parts that were longitudinally L spaced apart.

FIG. 3 shows that the card receiver is constructed with a main structure 12 that includes an upper wall 50 in the form of a plate, and a lower wall 20 in the form of a crosspiece. The upper and lower walls are joined at their transversely opposite sides by vertical side walls 16, as shown in FIG. 4. The front ends of the side walls merge with a front structure part that forms a down ramp 66 to guide the middle of the card leading edge downwardly, and that forms a pair of up ramps 60 (FIG. 3) to guide the opposite sides of the card upwardly, all into the card-receiving cavity 130. The rear end of the side walls connect to a rear structure part that projects downward and forms the stop 90 that limits forward card movement. All walls can be molded as a single structure.

While terms such as “upper” and “lower” have been used to describe the invention as it is illustrated, the card receiver can be used in any orientation.

2. Detailed Description of the Invention

In the description that follows, identical, similar, or analogous elements will be denoted by the same reference numbers.

Without implying any limitation a vertical orientation, a longitudinal orientation and a transverse orientation will be with respect of the V, L, T coordinate system indicated in the figures and a front orientation and rear orientation will be with reference to the forward direction of insertion of the card into the receiver case.

The receiver case 10 shown in the figures essentially consists of a plastic molded part 12 which is in the form of a part of generally rectangular parallelepipedal shape.

The card C, partly illustrated in FIG. 8, is here a SIM card of rectangular shape bounded laterally by two parallel longitudinal edges 14 and longitudinally by a front transverse edge 16 and by a rear transverse edge (not shown).

One of the two parallel plane faces of the card C is called its main face 17 on which are provided, in a known manner, conducting pads. The conducting pads here consist of two series of four front conducting pads FCPi and four rear conducting pads RCPi. The conducting pads of each series are aligned by two in pairs of front and rear pads, such as, for example, the pads FCP2 and RCP2 which constitute a pair of pads.

In FIG. 8, on each conducting pad the mean geometrical position of the point of contact to be established between the corresponding pad and a conducting blade of the receiver case 10 has been shown.

The part 12 (FIG. 4) has two opposed lateral walls 16 running longitudinally and vertically, the facing internal faces 18 (FIG. 2) of which constitute two slideways for the lateral guiding of the card C between which the longitudinal edges 14 (FIG. 8) of the card are housed during forward insertion of said card into the part 12, that is to say along the axis L indicated in the figures and in the direction “I” indicated on the card in FIG. 8.

The other face 132 of the card C has no conducting connection pads.

The two lateral slideways 18 are joined together, in a known manner, by a lower crosspiece 20 (FIG. 4) of rectangular plate shape.

The plate 20 here has a small width along the longitudinal axis L and is placed approximately halfway along the slideways 18.

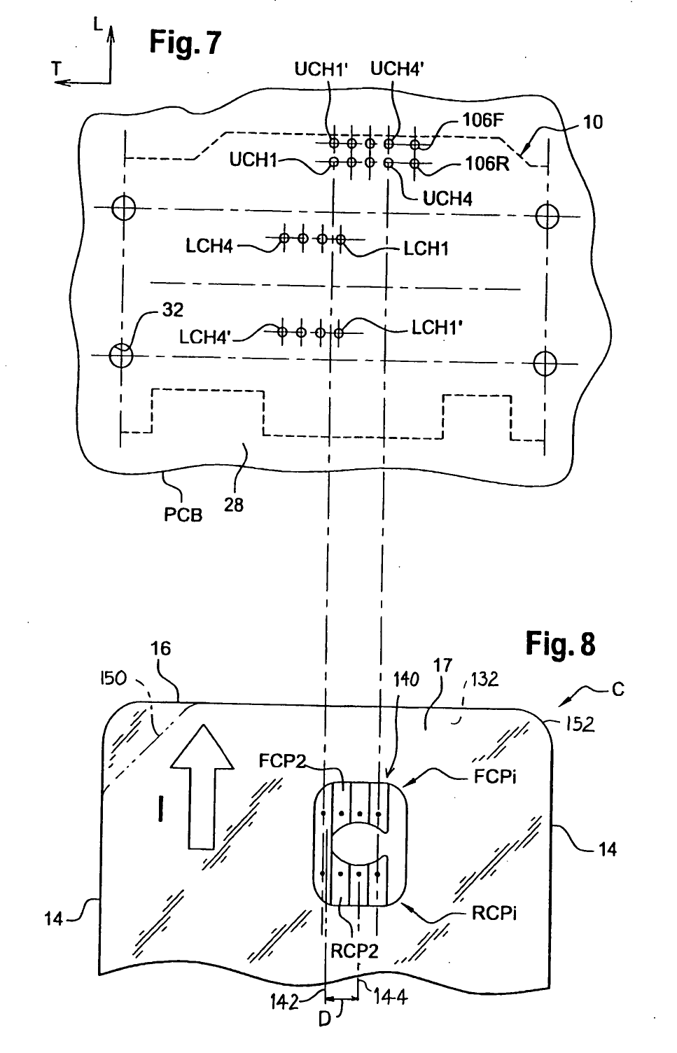

To position the case 10 on a printed-circuit board PCB as illustrated in FIG. 7 and to fix said case thereto, the molded part 12 (FIG. 4) has here four feet 22 each having an elastically deformable hook or barb. Each foot 22 has a shoulder 26 that bears on the upper face 28 of the board PCB, below which it is extended vertically downward by an alignment stud 30 intended to be housed in a corresponding hole 32 in the board PCB.

The shoulder 26 thus determines the height at which the upper crosspiece 20, and especially the horizontal lower face 34 of the latter, lies above the upper face 28 of the board PCB.

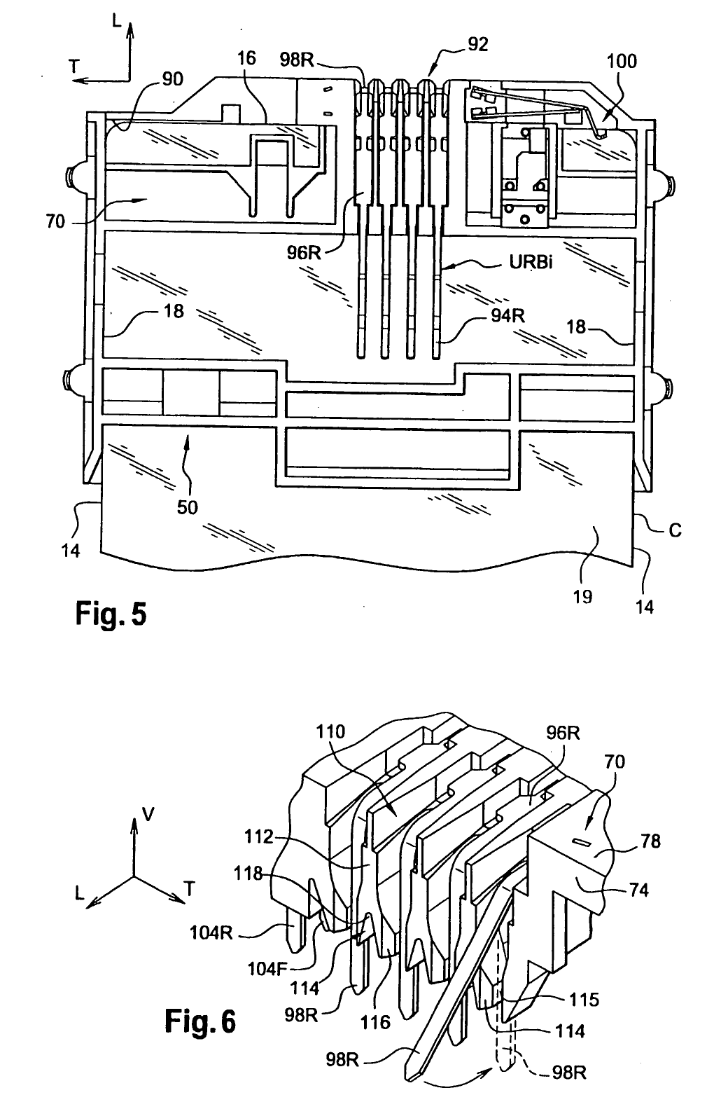

In its central part 21, the crosspiece 20 carries a lower connector 36, of known general design, for electrical connection to the card when the latter is inserted into the case 10 with its main face facing vertically downward, that is to say in the position illustrated in FIGS. 3 and 5.

The connector 36 is, for example, of the type described and shown in document WO-A-00/68867.

It essentially consists of an insulating body 38 (FIG. 3) made in the form of a rectangular parallelepipedal plate of insulating plastic, which is bounded by a plane horizontal lower face 40, which here bears vertically against a facing portion 42 of the middle central part 21 of the lower crosspiece 20 which is offset downward relative to the horizontal general plane of the crosspiece.

For positioning the connector 36 on the crosspiece 20, 21 and for fixing it thereto, the insulating body 38 has here two vertical lower fingers 44 housed in corresponding holes 46 in the part 21 of the lower crosspiece 20.

The insulating body 38 of the lower connector 36 has here, in a known manner, a group of eight lower contact blades.

To ensure electrical connection with the pairs (FCPi, RCPi) of aligned conducting pads on the card, the lower contact blades consist of a series of four lower front blades LFBi, which are aligned transversely, and of a series of four lower rear blades LRBi, which are also aligned transversely and offset longitudinally relative to the front blades LFBi.

Thus, the connector 36 has four pairs of aligned lower contact blades (LFBi, LRBi).

Each lower front LFBi or rear LRBi contact blade has a curved free contact end 47R, 47F whose convexity is oriented, in a known manner, vertically upward, and projects vertically upward beyond the upper horizontal plane face 41 of the insulating body 38 of the connector 36.

Each lower front contact blade has a tail, or connection portion 48F and likewise each rear blade has a tail, or connection portion 48R.

The tail portions 48F, 48R extend vertically downward and here are made in the form of the “pricking” type.

Each pricking portion 48F, 48R is designed to be housed in a corresponding hole in the printed-circuit board PCB.

For this purpose, as may be seen in FIG. 7 in which the outline of the case 10 has been shown in phantom lines, the board or PCB has a series of four transversely aligned front connection holes LCH1 and a series of four transversely aligned rear holes LCH1′, two holes LCH1, LCH1′ of a same row being longitudinally aligned so as to constitute a pair of associated holes.

Without departing from the scope of the invention, and by way of a variant (not shown), the insulating body of the lower connector may be made as one piece with the lower crosspiece, the corresponding part of which then carries directly the lower contact blades that are fitted by longitudinal insertion, or else by overmolding of the crosspiece around intermediate portions of the lower contact blades.

The slideways 18 (FIG. 4) are also joined together, at the front of the case 10, by a horizontal upper plate 50 for guiding the card, which plate is especially bounded vertically downward by a plane horizontal lower face 52.

Beyond the rear transverse edge 54 of the upper plate 50, the slideways 18 are extended longitudinally rearward and each of them carries a shoe 56 for guiding and supporting the card C while it is being inserted into the case 10.

Each shoe 56 (FIG. 4) is bounded vertically upward by a horizontal facet 58 (FIG. 3) which extends an insertion and guiding ramp 60, the facets 58 being coplanar with the upper face 41 of the lower connector 36.

As may be seen especially in FIG. 4, the lower face 52 has, beyond its rear transverse edge 54, inclined facets 62 forming guiding ramps, as does its central rear extension 64, comprising an insertion and guiding ramp 66.

The lower crosspiece 20 also includes, on each side of the connector 36, inclined ramps 68 which are also intended to cooperate with the front transverse edge 16 of the card C.

Together the lower crosspiece 20 and the upper plate 50 define between them a slot for the insertion and guiding of the card, the thickness or height of which corresponds approximately to the distance separating the coplanar surfaces 58, 52 of the crosspiece 50, this distance being slightly greater than the thickness of the card C so as to allow insertion of only a single card at the time.

According to the teachings of the invention, the receiver case 10 includes an upper connector portion which is carried by a rearward upper crosspiece 70 of transverse orientation, which itself also joins the two longitudinal slideways 18 with which it is produced here by being molded as a single piece.

The upper crosspiece 70 is in the general form of a rectangular plate and lies horizontally in the upper part of the case 10, approximately in the same plane in the rear upper guiding plate 50.

In top view, and as may be seen especially in FIG. 1, the central lower crosspiece 20 is located longitudinally between the rear upper guiding plate 50 and the upper front crosspiece 70, and is offset vertically downward relative to said plate and said crosspiece.

The upper crosspiece 70 is bounded longitudinally by a rear transverse edge 72 and by a front transverse edge 74.

It is bounded vertically by a lower horizontal face 76, which is coplanar with the lower face 52 of the front upper plate 50, and by a horizontal upper face 78, which is also approximately coplanar with the upper horizontal face 51 of the plate 50.

Thus, in the inserted position of the card C, the plane face of the latter, facing upward, cooperates with the lower face 76 of the upper crosspiece 70 which also lies opposite two parallel lower tabs 80 (which extend transversely inward from the slideways 18), each tab having an upper facet 82 that defines, with the facing portion of the face 76, the front longitudinal part of the slot for guiding the card C and for keeping it in position.

Again, in order to facilitate full insertion of the card, the upper crosspiece 70 has rear ramps 84 while the tabs 80 have ramps 86.

The extreme position of insertion of the card C in the case 10 is defined by its front transverse edge 16 coming into longitudinal abutment against a front vertical transverse edge 90 or stop on the rear of the upper partition 70.

The central part of the insulating body of the upper crosspiece 70 constitutes the insulating body of an upper electrical connector 92 which is therefore produced here as a single part with the upper crosspiece 70 by molding.

As a variant, not shown, the upper connector, like the lower connector 36, may be made in the form of an attached component fixed to the upper crosspiece 70.

The upper connector 92, like the lower connector 36, has a group of upper contact blades that are also eight in number, in the form of four pairs of two longitudinally aligned blades.

For this purpose, the connector 92 has a series of four upper front blades UFBi, aligned transversely, and a series of four upper rear blades URBi, which are also aligned transversely.

Thus, those upper front blades whose curved free ends are designed to come into contact with the front conducting pads FCPi of the card are called UFBi, while those rear upper blades whose curved free ends are designed to come into contact with rear conducting pads RCPi on the card C are called URBi.

As may especially be seen in FIG. 3, all the curved free ends 94R, 94F of the upper contact blades URBi and UFBi have their convexity oriented vertically downward so as to establish an approximately point electrical contact with the corresponding conducting pads on the main face 17 of the card C, when said main face is face up.

Each upper contact blade here is in the form of an elastically deformable beam and comprises, longitudinally toward the front beyond its curved rear longitudinal contact end 94R, 94F, an intermediate horizontal fitting portion 96R, 96F and, finally, a front longitudinal end portion of vertical orientation 98F, 98R for electrical connection of each contact blade in a conducting hole associated with the board PCB.

In the embodiment shown in the figures, each upper contact blade is fitted into the insulating body of the upper crosspiece 70 using the longitudinal insertion technique, well known in the field, each fitting portion 96R, 96F being here fitted longitudinally from the rear forward, that is to say from the top down when considering, for example, FIGS. 1 and 3.

As may be seen especially in FIG. 3, two associated upper contact blades, namely an upper front blade UFBi and an upper rear blade URBi, are superposed vertically one above the other so as to make it possible, on the one hand, for them to be inserted longitudinally into the insulating body of the upper connector and, on the other hand, for the various electrical contacts and connections to be established without any short circuit between the two blades of one and the same pair of upper blades.

For this purpose, the portion 96R of the rear upper blade for being fitted by insertion has a greater length than the fitting portion 96F of the upper front blade, thereby making it possible, on the one hand, for the curved free contact end 94R of the rear upper blade to be offset longitudinally rearward relative to that 94F of the upper front blade and, on the other hand, for the vertical connection portion 98R of the rear upper blade to be offset vertically rearward relative to the front vertical connection portion 98F of the upper front blade.

As may be seen in FIG. 3, the upper rear contact blade therefore completely overlaps the front contact blade.

As is illustrated schematically in phantom lines in the upper part of FIG. 3, each rear longitudinal end connection portion 98R, 98F extends initially horizontally in the plane of the fitting intermediate portion 96R, 96F that it extends, so as to allow simultaneous longitudinal insertion of all the blades of one and the same series that are, using a known technique, connected in a cluster by a linking strip, this strip then being cut off and the connection portions 98R, 98F then being bent through 90° (in the counterclockwise direction indicated in FIG. 3) in order to orient them in the vertical direction so that their free ends of the pricking type are then housed in the holes UCHi and UCHi′ of the board PCB.

To allow the connection portions 98F and 98R to be bent at right angles after the longitudinal insertion operation, the upper crosspiece 72 has, in the corresponding region, a series of four slots or notches 110 which extend vertically and longitudinally and emerge toward the front in the rear transverse face 74.

As may be seen in FIGS. 1 and 2, the two upper contact blades located transversely on the left, which extend vertically above the lower connector 36, are, of course, positioned transversely so as to be interposed between the lower contact blades of the lower connector 36 in order to prevent, in the absence of a card, undesirable electrical contacts or short circuit between the upper contact blades and the lower contact blades.

Finally, the case 10 includes here, in a known manner, a connector 100 for detecting the end of travel of insertion of the card C, which is here of the normally closed (NC) type and which is a switch having two blades, namely a rear blade 102R and a front blade 102F, each blade having a vertical connection portion of the pricking type 104R, 104F, these being housed in two aligned conducting holes 106R and 106F in the board PCB.

According to the invention, irrespective of the orientation of the main face 17 of the card C, that is to say whether it is face down or face up, the lower contact blades are elastically deformed and bear against a facing portion of that face of the card which faces down, and the upper contact blades are elastically deformed and bear elastically against the facing portion of that face of the card which faces up.

Depending on the orientation of the main face, either face down or face up, it is the group of lower contact blades, or contact blades belonging to the group of upper contact blades, that are in electrical contact with conducting pads on the card for connection to the electronic memory of the latter.

The alternative embodiment illustrated in FIG. 6 will now be described, in which the insulating body extends vertically over a larger height, that is to say in particular that the partitions 112, which separate the slots or notches 110 from one another, extend vertically over the greater part of the height of the pricking portions 98F, 98R.

Near its lower end, each partition 112 divides into a fork 114 so as to define, transversely on each side, portions 116 that project transversely with, between two opposed projections 116 of one and the same partition 112, a housing 118 in the form of an upside-down V allowing elastic deformation in the transverse direction.

In the lower part, the transverse width of each slot or notch 110 is therefore reduced by two projecting portions 116 and is thus slightly smaller than the transverse width of a connection portion 98R, which is a portion in the form of a blade or strip, as may be seen in FIG. 6.

Thus, during the 90° -bending operation, the lower part of each connection portion 98R, 98F is inserted between the opposed vertical faces 115 of two portions 116 between which it is inserted, by elastic deformation, in order to obtain a pinching or gripping effect on the lateral edges of the portion 98R, 98F so as to keep the latter in the bent position, that is to say in the desired vertical orientation.

1. A smart card receiver having a card-receiving cavity for receiving a smart card that has opposite card side edges, a front card edge, and main and second opposite card surfaces, the smart card having a plurality of contact pads on said main card surface, said card receiver having card-confining walls that determine the position of said card opposite sides and said front card edge in a fully inserted position of the card in said cavity, said card-confining walls having lower and upper cavity faces and said card receiver having a plurality of lower contact blades that have lower contacting parts that project above said lower cavity face to engage the contact pads when the card lies in a fully inserted position with its main card surface facing downwardly, wherein:
said card-confining walls allow said card to lie in a fully inserted position in said cavity with its main card surface facing either upward or downward; and including
a plurality of upper contact blades mounted on said walls and having upper contacting parts that project below said upper cavity face and that are positioned to engage said contact pads of said card when the card lies in a fully inserted position in said card-receiving space but with its main card surface facing upward.

2. The card receiver described in claim 1 wherein said card has an imaginary card centerline (142) that lies halfway between said opposite card side edges, and said plurality of contact pads are arranged in a pattern with a pad pattern centerline (144) that is parallel to said card centerline but that is offset from said card centerline, and wherein:
said lower contacting parts are offset in a first transverse direction from said card centerline, and said upper contacting parts are offset in an opposite second transverse direction from said card centerline.

3. The card receiver described in claim 1 wherein:
said lower contacting parts are transversely spaced apart;
at least one of said upper contacting parts lies transversely between two of said lower contacting parts.

4. The card receiver described in claim 1 wherein:
said card receiver includes a main structure with opposite side walls, with upper and lower crosspieces extending between said side walls, and with front and rear structure parts extending between said side walls;
said rear structure part forming upper and lower ramp surfaces that guide a card front edge into said card-receiving cavity;
said front structure part forming a stop that abuts the front edge of the card;
said lower crosspiece being spaced from said front and rear structure parts.

5. A smart card receiver having walls forming a card-receiving cavity for receiving a smart card having main and second opposite faces and having contact pads on said main face, said receiver having top and bottom walls lying below and above said cavity, including:
lower and upper contacts mounted respectively at said top and bottom walls;
said lower contacts being positioned to engage said card contact pads when said card is inserted into said cavity with said main face facing downward, and said upper contacts positioned to engage said card contact pads when said card is inserted into said cavity with said main face facing upward.

6. The card receiver described in claim 5 including:
at least a lower connector that includes an insulative body, said lower contacts being mounted on said insulative body and said insulative body having an upper surface that forms part of said lower wall.

7. The smart card receiver described in claim 5 wherein said smart card has a front edge, and a frontmost of said contact pads are spaced a predetermined position rearward of said front edge, and wherein:
said smart card receiver has a front stop that engages said smart card front edge, said frontmost contact pads spaced the same distance from said stop when said card main face faces downward as when said main face faces upward.

8. The card receiver described in claim 5 wherein said card has an imaginary card centerline that lies halfway between said opposite card side edges, and said plurality of contact pads are arranged in a pattern with a pattern centerline that is parallel to said card centerline but that is transversely offset from said card centerline, and wherein:
said card-engaging lower contacting parts are offset in a first transverse direction from said card centerline, and said upper card-engaging contacting parts are offset in an opposite second transverse direction from said card centerline.

9. A smart card receiver comprising:
a main structure that has card-confining walls that form a card-receiving cavity, said walls including a lower wall, an upper wall, and transversely opposite side walls;
said main structure having a rear structure part with at least one ramp surface that guides a card into said cavity;
said main structure having a front structure part forming a stop that engages a front of a fully inserted card;
said main structure having a crosspiece lying extending between said opposite side walls, said crosspiece being spaced rearward of said front structure part and being spaced forward of said rear structure part.

10. The card receiver described in claim 9 including:
a connector that includes an insulative body and a plurality of lower contact blades mounted in said body, said connector mounted on said crosspiece with said contact blades having contacting parts that project upward into said cavity.

11. The card receiver described in claim 9 including:
lower and upper contact blades mounted respectively on said crosspiece and on said top horizontal plate portion, said lower contact blades having card-engaging contacting parts that project upwardly into said cavity, and said upper contact blades have card-engaging contacting parts that project downwardly into said cavity.
